(19) United States
(12) Patent Application Publication
(10) Pub. No.: US 2003/0223091 A1
(43) Pub. Date: Dec. 4, 2003

(54) Method and implementation of capturing print data from heterogeneous networked clients

(76) Inventor: Manmohan M. Garg, Cerritos, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/156,507

(22) Filed: May 28, 2002

(51) Int. Cl. B41B 1/00; G06F 15/00; G06K 1/00

(52) U.S. Cl. 358/1.15

(57) ABSTRACT

A method and implementation of network printing is disclosed. A print job is generated from a network client. A runtime printing component is plugged into a networking layer for a network client. Print data is captured from the print job in chunks using the continue printing component. The captured data is fed to a printer controller of a printing system without involving a native print system of a network operating system.

### BACKGROUND OF THE INVENTION

The present invention is direct to the field of network printing. The invention has particular applicability to network printing where a number of clients and network servers employ a variety of different operating systems.

Many network servers operate with UNIX or “Windows” based operating systems. However, Linux is increasingly becoming a popular operating system for network systems. In particular, Linux is becoming an attractive operating system for developing embedded print controllers for network printers. However, it can be difficult to interface a Linux network with various types of client machines since the network must connect and receive print requests and data from all types of client operating systems.

Some previous-type solutions have been contemplated for enabling network connectivity with Linux. On the printing side, most of these connectivity solutions employ a rudimentary inbuilt spooler to spool print data and call the native Linux print system to forward the printing job to the actual printer. However, this approach suffers from certain problems. Incompatibility between a client operating system and Linux can cause a loose link between the printing system and the network connectivity, resulting in a loss of throughput and a loss of client information, such as the identity of the user submitting the job.

### SUMMARY OF THE INVENTION

The difficulties and drawbacks associated with previous solutions are overcome by the method and implementation of network printing in accordance with the present invention. A print job is generated from a network client. A runtime printing component is plugged into a networking layer for a network client. Print data is captured from the print job in chunks using the continue printing component. The captured data is fed to a printer controller of a printing system without involving a native print system of a network operating system. As will be realized, the invention is capable of other different embodiments and its several details are capable of modifications in various respects, all without departing from the invention. Accordingly, the drawing and description are to be regarded as illustrative and not restrictive.

### BRIEF DESCRIPTION OF THE DRAWING

FIG. 1 is a block diagram showing interactions between the elements of an exemplary embodiment of the invention.

### DETAILED DESCRIPTION OF THE INVENTION

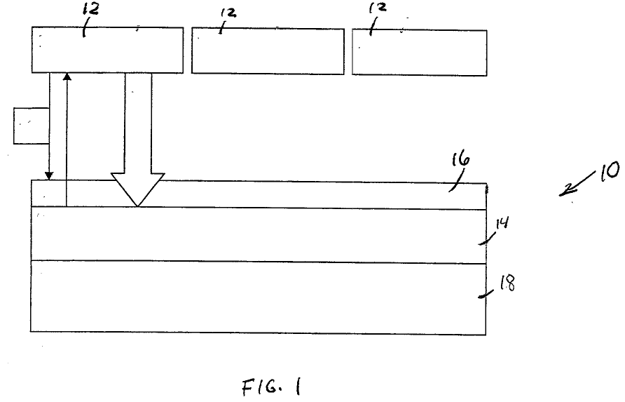

As shown in FIG. 1, the computer-based method and software implementation of the present invention includes a routine pluggable printing component 10 that can be plugged into the networking layers 12 of a network client. When the network client generates a print job, the network layers 12 are configured to interact with different types of client machines that can be running different types of operating systems, e.g., Windows, Linux, etc. and provide facility to the clients to submit documents for printing.

The invention comprises a pluggable spooler 14 that operates under the operating system of the network server, preferably Linux, though it is understood that the invention can be adapted to any operating system. The pluggable spooler 14 delivers print documents to the printer controller 16 of a print system, where hard copy documents are produced.

When the step of generating the print job is complete, the networking layers 12 invoke the printing system. The invocation happens in the form of dynamically loading symbols from a shared library. This dynamic loading of symbols is effective to plug-in print services to the networking layers in the form of calls like CreatePrintJob, PushData, StartPage/EndPage, EndPrintJob along with job management services like GetJobsList, GetJobInformation/Status, PauseJob, CancelJob etc. The pluggable component 10 is built from these loaded symbols. In one aspect, this can be carried out by calling a dlopen/dlsys combination of functions in Linux. By building the pluggable component in this manner, it is suitable to plug the component with “open source” components without having to link with them.

After the pluggable component 10 is built, data transfer is commenced. The pluggable component 10 publishes a printing interface, e.g., a loader component 16, that is used to deliver print documents from the networking layers 12 to the printer controller 18. The loader component 16 keeps the printing system disjointed from the networking layers 12, thereby removing the need to link the printing spooler 14 with networking components. The loader component 16 provides pointers between the client networking layers 12 and the print spooler 14.

The pluggable printing component 10 captures print data in chunks directly from the client networking layers 12. The print spooler 14 then feeds the chunks directly to the print controller 18 of the print system. The print spooler 14 interacts with the print system and could be loosely connected or linked to the print system. The present pluggable component 10 allows continuous processing of documents while the data chunks are being received, allowing the data stream to flow continuously from the client machine to the printer system, so that the print job starts processing without delay as the data arrives.

The present invention can also feed back a job list of printer jobs in process to the client machine. The present method and implementation can be facilitated by modifying the code in the network layer. These modifications are easily realized for most common network connectivity layers, e.g., using Linux viz. Samba (for “Windows” connectivity) and CUPS (Common UNIX Printing System) for connectivity with IPP (Internet Print Protocol). Other modifications can be contemplated without departing from the invention.

As described hereinabove, the present invention solves many problems associated with previous type systems. However, it will be appreciated that various changes in the details, materials and arrangements of parts which have been herein described and illustrated in order to explain the nature of the invention may be made by those skilled in the area within the principals and scope of the invention will be expressed in the appended claims.

I claim:

1. A method of network printing comprising:
generating a print job from a network client;
plugging a runtime printing component into a networking layer for the network client;
capturing print data from the print job in chunks using the runtime printing component;
feeding the captured data to a printer controller of a printing system, without involving a native print system of a network operating system.

2. The method of claim 1 wherein the step of plugging a runtime printing component comprises plugging a pluggable print spooler that interacts directly with the printing system.

3. The method of claim 2 wherein the step of plugging a runtime printing component comprises employing a loader component that provides pointers between the networking layer and the print spooler.

4. The method of claim 1 wherein the step of plugging comprises plugging the runtime printing component into the networking layer of a Linux operating system.

5. The method of claim 1 wherein, after the step of generating the print job is complete, and before the step of capturing, a step is provided in invoking the printing system from the networking layer.

6. The method of claim 5 wherein the step of invoking the printing system comprises the step of plugging the runtime printing component.

7. The method of claim 5 wherein the step of invoking the printing system comprises dynamically loading symbols from a shared library.

8. The method of claim 7 wherein the step of dynamically loading symbols comprises calling a dlopen/dlsys combination of functions in a Linux operating system.

9. The method of claim 1 further comprising a step of feeding back a job list to the network client.

10. A pluggable runtime print component comprising:
an implementation for plugging into a networking layer upon generation of a print job by a network client;
an implementation for capturing print data from the print job in chunks;
an implementation for feeding the captured print data to a printer controller of a printing system, without involving a native print system of a network operating system.

11. The pluggable runtime print component of claim 10 wherein the implementation for feeding comprises a pluggable print spooler that interacts directly with the printing system.

12. The pluggable runtime print component of claim 11 wherein the implementation for capturing print data comprises a loader component that provides pointers between the networking layer and the print spooler.

13. The pluggable runtime print component of claim 10 wherein the implementation for plugging comprises plugging into the networking layer of a Linux operating system.

14. The pluggable runtime print component of claim 10 further comprising an implementation for involving the printing system from the networking layer upon completion of the generation of the print job.

15. The pluggable runtime print component of claim 14 wherein the implementation for involving comprises an implementation for dynamically loading symbols from a shared library.

16. The pluggable runtime print component of claim 15 wherein the implementation for dynamically loading symbols comprises an implementation for calling a dlopen/dlsys combination of functions in a Linux operating system.

17. The pluggable runtime print controller of claim 10 further comprises an implementation for feeding back a job list to the network client.
